(19) United States
(12) Patent Application Publication
(10) Pub. No.: US 2017/0148225 A1
(43) Pub. Date: May 25, 2017

(54) VIRTUAL DRESSING SYSTEM AND VIRTUAL DRESSING METHOD

(71) Applicants: Inventec (Pudong) Technology Corporation, Shanghai (CN); INVENTEC CORPORATION, TAIPEI CITY (TW)

(72) Inventor: Shih-Hsin HSU, TAIPEI CITY (TW)

(21) Appl. No.: 15/098,325

(22) Filed: Apr. 14, 2016

(30) Foreign Application Priority Data
Nov. 20, 2015 (CN) 201510808684.2

(51) Int. Cl. G06T 19/20

(52) U.S. Cl. CPC G06T 19/20; G06T 2200/08; G06T 2200/04; G06T 2215/16

(57) ABSTRACT

A virtual dressing method includes the following steps. A three-dimensional user image and a body characteristic parameter are stored in a data storage carrier. A clothing image and a clothing characteristic parameter are read from a database. The body characteristic parameter and the three-dimensional user image are read from the data storage carrier. The body characteristic parameter is compared with the clothing characteristic parameter to generate a corresponding relationship. A three-dimensional virtual image is generated based on the corresponding relationship, the clothing image, and the three-dimensional user image. The three-dimensional virtual image is displayed.

### RELATED APPLICATIONS

This application claims priority to Chinese Application Serial Number 201510808684.2, filed Nov. 20, 2015, which is herein incorporated by reference.

### BACKGROUND

Field of Invention

The present invention relates to a virtual dressing system and a virtual dressing method. More particularly, the present invention relates to a virtual dressing system and a virtual dressing method able to display a three-dimensional virtual image.

Description of Related Art

Because online shopping is increasingly popular, many customers will purchase wearable merchandise, such as clothes, pants, hats, backpacks, etc through the Internet. However, problems, such as that the size purchased does not fit and aesthetic feeling is not the same as that shown in the advertisement, are frequently encountered. As a result, a lot of money and time are wasted on shopping. In addition, even if customers go to physical stores, it still takes them time to try on the clothes that they intend to buy before they can have a feeling for how they look in these clothes.

For the forgoing reasons, there is a need to decrease the occurrence of situation of exchanging size or inconsistency with expectation by directly simulating how dressed people look.

### SUMMARY

A virtual dressing system is provided. The virtual dressing system comprises a data storage carrier and an electronic device. The electronic device comprises a database, a processor, and a display. The data storage carrier is configured to store a three-dimensional user image and a body characteristic parameter. The database is configured to store a clothing image and a clothing characteristic parameter. The processor is configured to read the clothing characteristic parameter and the clothing image from the database, and read the body characteristic parameter and the three-dimensional user image from the data storage carrier, and compare the body characteristic parameter with the clothing characteristic parameter to generate a corresponding relationship, and generate a three-dimensional virtual image based on the corresponding relationship, the clothing image, and the three-dimensional user image.

The invention provides a virtual dressing method. The virtual dressing method comprises the following steps: storing a three-dimensional user image and a body characteristic parameter in a data storage carrier; reading a clothing image and a clothing characteristic parameter from a database, and reading the body characteristic parameter and the three-dimensional user image from the data storage carrier; comparing the body characteristic parameter with the clothing characteristic parameter to generate a corresponding relationship; generating a three-dimensional virtual image based on the corresponding relationship, the clothing image, and the three-dimensional user image; and displaying the three-dimensional virtual image.

In summary, the technical solution of the present invention has obvious advantages and beneficial effects as compared with the prior art. Through the above technical solution, considerable advances in technology and extensive industrial applicability can be achieved. The present invention can allow the users to directly view how they look in the clothes that they intend to buy through the display of the virtual dressing system, and the data storage carrier of the user can more conveniently carry the body characteristic parameters. In addition, the user can also apply the body characteristic parameter to various virtual reality systems to simulate the three-dimensional virtual images of the user dressed in different clothes after applying a variety of clothing images.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 depicts a block diagram of a virtual dressing system according to one embodiment of this invention;

FIG. 2A to FIG. 2C depict schematic diagrams of a virtual dressing method according to one embodiment of this invention; and

FIG. 3 depicts a flowchart of a virtual dressing method according to one embodiment of this invention.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts.

As used herein, “electrically connect” refers to direct physical contact or electrical contact or indirect physical contact or electrical contact between two or more devices. Or, “electrically connect” can also refer to reciprocal operations or actions between two or more devices.

It should be understood that the terms, “comprising”, “including”, “having”, “containing”, “involving” and the like, used herein are open-ended, that is, including but not limited to.

It will be understood that, as used herein, the phrase “and/or” includes any and all combinations of one or more of the associated listed items.

Terms used herein typically have common meanings for each of the terms used in this field, in the present disclosure and in special contents, unless specially noted. Some teems for describing the present disclosure will be discussed in the following or elsewhere in this specification for providing practitioners with additional guidance related to the description of the present disclosure.

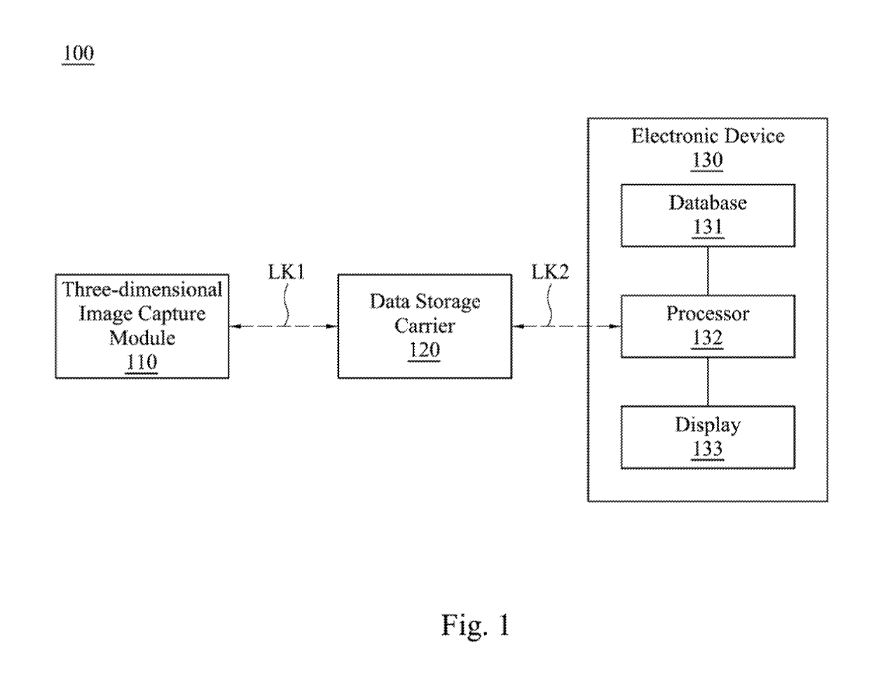

A description is provided with reference to FIG. 1. FIG. 1 depicts a block diagram of a virtual dressing system 100 according to one embodiment of this invention. According to the present embodiment, the virtual dressing system 100 comprises a three-dimensional image capture module 110, a data storage carrier 120, and an electronic device 130. The electronic device 130 comprises a database 131 and a processor 132. The data storage carrier 120 is configured to store a three-dimensional user image and a body characteristic parameter. The database 131 is configured to store a clothing image and a clothing characteristic parameter. The processor 132 is configured to read the clothing characteristic parameter and the clothing image from the database 131 and read the body characteristic parameter and the three-dimensional user image from the data storage carrier 120 to compare the body characteristic parameter with the clothing characteristic parameter so as to generate a corresponding relationship. A three-dimensional virtual image is generated based on the corresponding relationship, the clothing image, and the three-dimensional user image. In one embodiment, the electronic device 130 comprises a display 133 configured to display the three-dimensional virtual image.

In this manner, a user can store the body characteristic parameter of the user in the data storage carrier 120. And, the user can carry the body characteristic parameter more conveniently by using the data storage carrier 120. In addition, the user can also apply the body characteristic parameter to various virtual reality systems to simulate the three-dimensional virtual images of the user dressed in different clothes after applying a variety of clothing images.

In some embodiments, the virtual dressing system 100 may further comprise a three-dimensional image capture module 110 configured to take a picture of a user to generate a three-dimensional user image and obtain a body characteristic parameter of the user. In one embodiment, the three-dimensional image capture module 110 may comprise multiple camera lenses and multiple infrared sensors. The plurality of camera lenses are configured to take pictures of different parts of a body or take pictures of the body at different view angles. The infrared sensors can sense depth information of the different parts of the body relative to the three-dimensional mage capture module 110. In this manner, the three-dimensional image capture module 110 can obtain body characteristic parameters of the user by using the captured body images and the sensed depth information so as to establish fixed points of the different parts of the body of the user in three-dimensional coordinates and generate the three-dimensional user image of the user.

In one embodiment, the data storage carrier 120 is a portable storage device such as a card-type device having a near field communication (NFC) function, a memory card, or a flash disk having a universal serial bus (USB). In one embodiment, the data storage carrier 120 can further have the near field communication function, a Bluetooth function, a WiFi function, or some other wireless/wired data transmission functions in addition to being able to store data. In another embodiment, the data storage carrier 120 may be located in a portable electronic device, a cloud system, or a personal computer. For example, the data storage carrier 120 may be a module or a circuit having the near field communication function and a storage function and is comprised in an intelligent cell phone. Or, the data storage carrier 120 may be a hard disk, a memory, or a flash disk and is located in a server of a cloud system or a personal computer.

In one embodiment, the electronic device 130 may be a personal computer, an intelligent cell phone, a tablet computer, a smart TV, or any device having the storage function and a processing function. In addition, the electronic device 130 comprises the database 131, the processor 132, and the display 133. In one embodiment, the database 131 is configured to store various data and can be implemented by using a memory, a hard disk, a flash disk, or a memory card, etc. In one embodiment, the processor 132 is configured to perform a variety of operations and can be implemented by using an integrated circuit, such as a microcontroller, a microprocessor, a digital signal processor, an application specific integrated circuit (ASIC), or a logic circuit. In one embodiment, the display 133 is configured to display operation results of the processor 132.

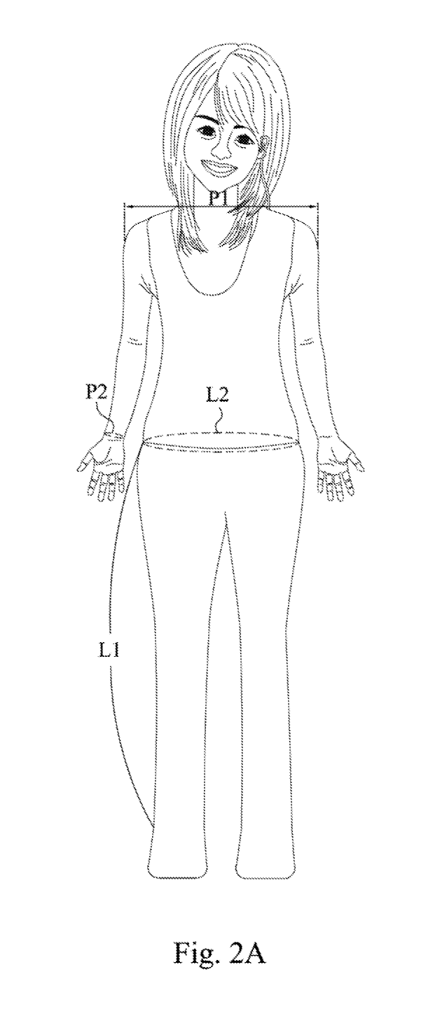

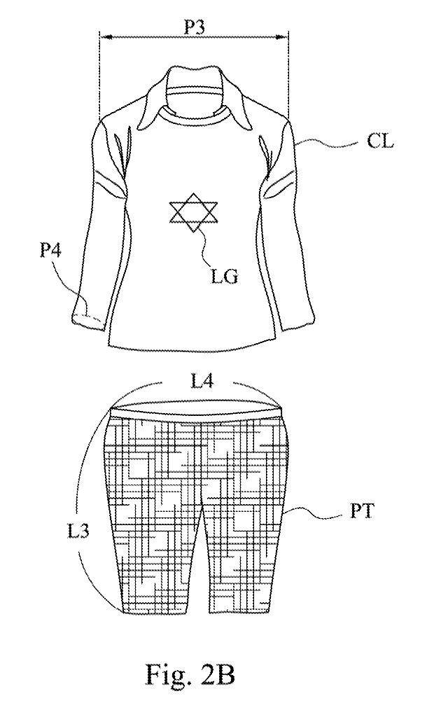

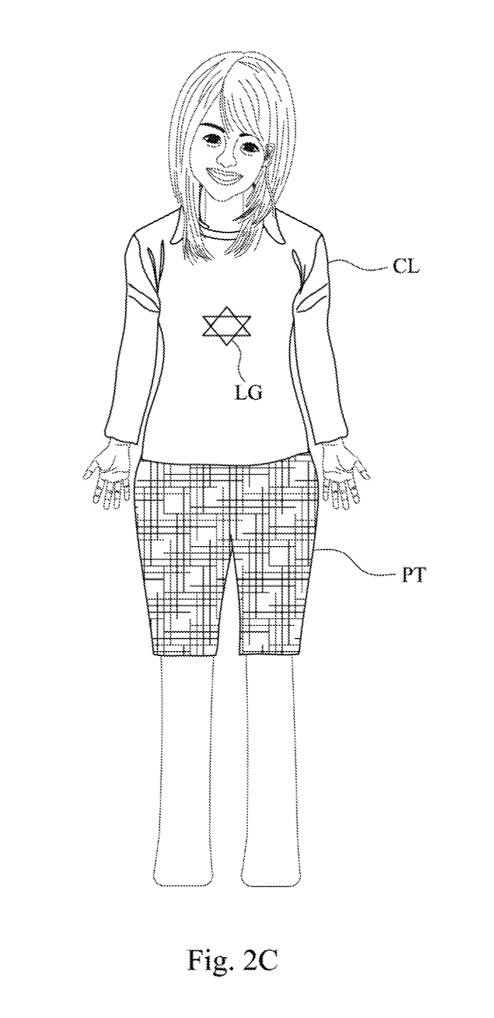

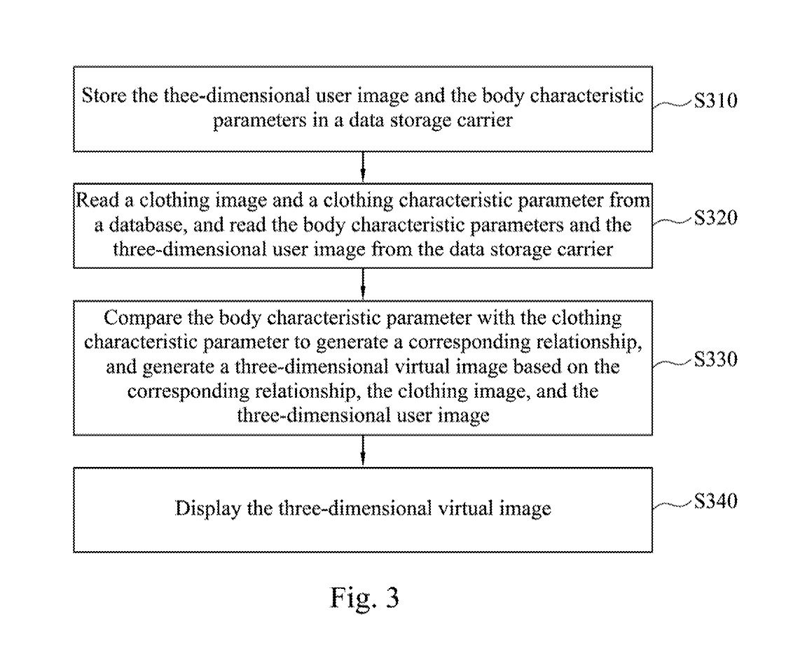

A description is provided with reference to FIG. 2A to FIG. 2C and FIG. 3. FIG. 2A to FIG. 2C depict schematic diagrams of a virtual dressing method according to one embodiment of this invention. FIG. 3 depicts a flowchart of a virtual dressing method according to one embodiment of this invention. An illustration is provided as follows with reference to the virtual dressing system 100 shown in FIG. 1 to provide a detailed description of the present invention. However, the present invention is not limited to the following embodiments.

In step S310, the data storage carrier 120 stores the three-dimensional user image and the body characteristic parameters. In one embodiment, the body characteristic parameter, for example, is a shoulder width P1, a wrist circumference P2, a leg length L1, or a waist circumference L2 of a body shown in FIG. 2A.

In one embodiment, the virtual dressing system 100 can take pictures of the user by using the three-dimensional image capture module 110 to generate the three-dimensional user image and obtain the body characteristic parameters of the user. Then, the three-dimensional user image and the body characteristic parameters are stored in the data storage carrier 120. In one embodiment, the three-dimensional image capture module 110 can be placed at a fixed location, for example, at a convenience store, at a clothing store, or at the users home. After the user is photoed by the three-dimensional image capture module 110, the three-dimensional image capture module 110 save the three-dimensional user image and the body characteristic parameters generated by it in the data storage carrier 120.

In one embodiment, the three-dimensional image capture module 110 can obtain the body characteristic parameters of the user based on the captured body images and the sensed depth information so as to establish the fixed points of the different parts of the body of the user in three-dimensional coordinates and generate the three-dimensional user image of the user. In one embodiment, the concept of measuring field lighting in the measurement environment reflected by the object can be applied by the three-dimensional image capture module 110 to calculate and obtain positions of the different parts of the body in a three-dimensional space. In one embodiment, the three-dimensional image capture module 110 can also apply known technologies, such as attaching sensors to the different parts of the body, using a three-dimensional camera in cooperation with a projection light source and/or the laser triangulation method to obtain the body characteristic parameters and construct or generate the three-dimensional user image of the user, thereby completing three-dimensional body scans.

In another embodiment, the virtual dressing system 100 can access known body characteristic parameters in another storage equipment (such as a cloud system, a server, or some other personal computer) through a wired or wireless transmission method. In this manner, the accessed body characteristic parameters are imported into the virtual dressing system 100.

After the body characteristic parameters of the user are obtained by using the above method, the virtual dressing system 100 can save the three-dimensional user image and the body characteristic parameters in the data storage carrier 120. For example, after the three-dimensional image capture module 110 establishes a first communication link LK1 with the data storage carrier 120, the three-dimensional user image and the body characteristic parameters are transmitted to a portable electronic device (such as an intelligent cell phone, a notebook computer) of the user or the data storage carrier 120 of a cloud system via the first communication link LK1 (such as Bluetooth, WiFi, near field communication, or some other network communication method). In this manner, the user can obtain the personal three-dimensional user image and body characteristic parameters at any time and place. When the user needs such type of data, it can be accessed from a portable electronic device carried by the user or downloaded from a cloud system via a network.

After the three-dimensional user image and the body characteristic parameters are stored in the data storage carrier 120, the user can utilize data stored in the data storage carrier 120 on different occasions so as to try on clothes at different stores or on different shopping platforms by using the electronic device 130. In this manner, for example, the dressing device that needs to be disposed by each of the stores may comprise the electronic device 130 shown in FIG. 1, but does not necessarily comprise the lenses or module for capturing three-dimensional images. As a result, not only the space and cost for disposing the dressing device of the store are saved, but the dressing efficiency of the user is also accelerated without measuring body parameters repeatedly.

In step S320, the processor 132 reads a clothing image and a clothing characteristic parameter from the database 131. The processor 132 also reads the body characteristic parameters and the three-dimensional user image from the data storage carrier 120.

In one embodiment, the database 131 may store the clothing image and the clothing characteristic parameter in advance. Contents of the clothing image may comprise a type of clothing (such as a top, pant, a hat, shoes) and/or an image thereof. In one embodiment, various clothing and accessories vendors can take a three-dimensional picture of a piece of clothing in advance, which includes, for example, a top image CL, a pattern LG of the top image CL, and a pant image PT shown in FIG. 2B.

In one embodiment, the clothing characteristic parameter may be a dimension of one part of a piece of clothing. For example, as shown in FIG. 2B, the clothing characteristic parameter may be a shoulder length P3 of the top image CL, a sleeve opening circumference P4 of the top image CL, a pant length L3 of the pant image PT, or a pant waist L4 of the pant image PT.

In one embodiment, the above clothing image and clothing characteristic parameter may be manually input into the database 131 by the various clothing and accessories vendors in advance. Or, the virtual addressing system 110 automatically imports an existing file into the database 131, directly.

In addition, in this step, the processor 132 can also read the body characteristic parameters and the three-dimensional user image from the data storage carrier 120. For example, after the data storage carrier 120 establishes a second communication link LK2 (such as Bluetooth, WiFi, near field communication, or some other network communication method) with the electronic device 130, the processor 132 can read the body characteristic parameters and the three-dimensional user image stored in the data storage carrier 120 via the second communication link LK2. The following embodiment is used for describing the data transmission method between the data storage carrier 120 and the electronic device 130.

In one embodiment, the data storage carrier 120 is a card-type device having the near field communication function. When a distance between the data storage carrier 120 and the electronic device 130 is smaller than a distance threshold value, the data storage carrier 120 transmits the three-dimensional user image and the body characteristic parameters to the electronic device 130.

In one embodiment, the data storage carrier 120 is a memory card or a flash disk having a universal serial bus (USB). When the data storage carrier 120 is electrically connected to the electronic device 130 (for example, the memory card or the USB flash disk is inserted into a communication interface of the electronic device), the data storage carrier 120 transmits the three-dimensional user image and the body characteristic parameters to the electronic device 130.

By performing the steps mentioned previously, the electronic device 130 can only obtain the body characteristic parameters and the three-dimensional user image of the user through reading the data storage carrier 120. As a result, the privacy of the user's data is enhanced, and at the same time, the user can carry such data with him/her.

In step S330, the processor 132 compares the body characteristic parameter with the clothing characteristic parameter to generate a corresponding relationship, and generates a three-dimensional virtual image based on the corresponding relationship, the clothing image, and the three-dimensional user image.

In one embodiment, the processor 132 compares the part of the body (such as a leg) of the user with a clothing part (such as a pant part of a piece of clothing) corresponding to the part of the body. For example, the processor 132 compares the wrist circumference P2 of the user with the sleeve opening circumference P4 of the piece of clothing to generate a corresponding relationship.

In one embodiment, the processor 132 compares a coordinate position of the part of the body (such as a shoulder) of the user with a coordinate position of a clothing part (such as a shoulder part of a piece of clothing) corresponding to the part of the body in a three-dimensional coordinate system so as to generate a corresponding relationship between the part of the body of the user and the clothing part corresponding to the part of the body.

In another embodiment, the processor 132 uses a known three-dimensional image comparison method or a known three-dimensional image positioning method to search for a part of the body (such as a wrist) of the user and the clothing part (such as a sleeve opening part of a piece of clothing) corresponding to the part of the body. Then, the processor 132 compares a dimension of the part of the body of the user with a dimension of the clothing part corresponding to the part of the body to generate a corresponding relationship (such as a relative visual effect that the sleeve opening circumference is much larger than the wrist circumference), and generates a three-dimensional virtual image based on the corresponding relationship, the clothing image, and the three-dimensional user image.

For example, when the processor 132 determines that the wrist circumference P2 (such as 20 centimeters) of the user is smaller than the sleeve opening circumference P4 (such as 40 centimeters) of the piece of clothing, a visual effect that the sleeve opening is more loose will be shown when the user wears the piece of clothing. When the processor 132 determines that the wrist circumference P2 (such as 20 centimeters) of the user is approximately equal to the sleeve opening circumference P4 (such as 20.5 centimeters) of the piece of clothing, a visual effect that the sleeve opening is more tight will be shown when the user wears the piece of clothing. In one embodiment, when the processor 132 determines that the wrist circumference P2 (such as 20 centimeters) of the user is larger than the sleeve opening circumference P4 (such as 10 centimeters) of the piece of clothing, the processor 132 will prompt the display 133 to show a message that the item does not fit to notify the user that the piece of clothing is too small for the user to wear.

After that, the processor 132 generates a three-dimensional virtual image based on the corresponding relationship, the clothing image, and the three-dimensional user image. In one embodiment, as shown in FIG. 2C, the processor 132 can use a layer superposition method to overlay the three-dimensional user image with the clothing image according to the corresponding relationship so as to complete the synthesis of the image.

It is thus understood that the processor 132 can determine whether a specific piece of clothing fits a figure of the user by using the body characteristic parameter and the clothing characteristic parameter to complete the synthesis of the image so as to generate the three-dimensional virtual image.

In step S340, the display 133 displays the three-dimensional virtual image. In this manner, the user can view the virtual dressing effect through the display 133 to complete one virtual dressing process performed by the user. In one embodiment, the user can touch the display 133 or operate a mouse cursor to rotate the view angle of the three-dimensional virtual image.

In addition, the virtual dressing system 100 can also be combined with a shopping management system to allow the user to access the data storage carrier 120 at any time and place so as to obtain the body characteristic parameters and the three-dimensional user image, and apply information in the data storage carrier 120 to different shopping management system.

For example, when the user surfs the Internet at home, the data in the data storage carrier 120 (such as a flash disk having a universal serial bus (USB)) can be transmitted to the electronic device 130 (such as a computer at home), such that the electronic device 130 obtains the piece of clothing intended to be purchased by the user and a size thereof from the shopping website and simulates the visual effect after the user wears the piece of clothing by using the above-mentioned method.

In addition, for example, when the user goes to a physical store to select clothing, the data in the data storage carrier 120 (such as a card-type device having the near field communication (NFC) function) can be transmitted to the electronic device 130 (such as a computer in a physical store) to simulate the visual effect after the user wears the selected piece of clothing. Moreover, when the user goes to another physical store to select clothing, the data in the data storage carrier 120 can be transmitted to the electronic device 130 (such as a computer in another physical store) again to simulate the visual effect after the user wears the selected piece of clothing again, thus saving the time spent on lining up by the user to wait for trying on the clothing in a crowded store.

In addition, in the above example, the present invention can be further combined with an online checkout system of the vendor to allow the user to directly check out merchandise online after the user views the virtual effect shown by the virtual dressing system 100 so as to make the shopping process go more smoothly.

Additionally, the virtual dressing system 100 can have a function of clothing recommendation. For example, after the processor 132 reads the body characteristic parameters and the three-dimensional user image from the data storage carrier 120, the virtual dressing system 100 can select a piece of clothing most suitable to the user's figure from the database 131. For example, the processor 132 determines that a piece of clothing has a size closest to dimensions of various parts of the body of the user and fits the various parts of the body of the user and displays the piece of clothing on the display 133 to recommend the user to further select the piece of clothing.

In addition to that, the virtual dressing system can be combined with a health management system to manage a feature change of the user. For example, the virtual dressing system 100 compares the three-dimensional user image and the body characteristic parameters every six months to remind the user of the feature change.

In addition, the virtual dressing system can be combined with a virtual reality system. The virtual dressing system 100 can apply the three-dimensional virtual image to a back style of a virtual reality to present the visual effect of the user in the piece of clothing under a certain circumstance.

In summary, the virtual dressing system and the virtual dressing method according to the present invention allow the user to store his/her body characteristic parameters in the data storage carrier 120 and carry the body characteristic parameters more conveniently by using the data storage carrier 120. In addition, the user can also apply the body characteristic parameters to various virtual reality systems to simulate the three-dimensional virtual images of the user dressed in different clothes after applying a variety of clothing images, thus decreasing the occurrence of situation of exchanging merchandise because the user purchases clothing in sizes that do not fit.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A virtual dressing system comprising:
a data storage carrier configured to store a three-dimensional user image and a body characteristic parameter; and
an electronic device comprising:
a database configured to store a clothing image and a clothing characteristic parameter; and
a processor configured to read the clothing characteristic parameter and the clothing image from the database, and read the body characteristic parameter and the three-dimensional user image from the data storage carrier, and compare the body characteristic parameter with the clothing characteristic parameter to generate a corresponding relationship, and generate a three-dimensional virtual image based on the corresponding relationship, the clothing image, and the three-dimensional user image.

2. The virtual dressing system of claim 1, further comprising:
a three-dimensional image capture module configured to take a picture of a user to generate the three-dimensional user image and obtain the body characteristic parameter of the user.

3. The virtual dressing system of claim 1, wherein the data storage carrier is a portable storage device.

4. The virtual dressing system of claim 1, wherein when a distance between the data storage carrier and the electronic device is smaller than a distance threshold value, the data storage carrier transmits the three-dimensional user image and the body characteristic parameter to the electronic device.

5. The virtual dressing system of claim 1, wherein when the data storage carrier is electrically connected to the electronic device, the data storage carrier transmits the three-dimensional user image and the body characteristic parameter to the electronic device.

6. The virtual dressing system of claim 1, wherein the data storage carrier is located in a portable electronic device, a cloud system, or a personal computer.

7. A virtual dressing method comprising:
storing a three-dimensional user image and a body characteristic parameter in a data storage carrier;
reading a clothing image and a clothing characteristic parameter from a database, and reading the body characteristic parameter and the three-dimensional user image from the data storage carrier;
comparing the body characteristic parameter with the clothing characteristic parameter to generate a corresponding relationship;
generating a three-dimensional virtual image based on the corresponding relationship, the clothing image, and the three-dimensional user image; and
displaying the three-dimensional virtual image.

8. The virtual dressing method of claim 7, further comprising:
taking a picture of a user to generate the three-dimensional user image and obtain the body characteristic parameter of the user.

9. The virtual dressing method of claim 7, wherein when a distance between the data storage carrier and the electronic device is smaller than a distance threshold value, the data storage carrier transmits the three-dimensional user image and the body characteristic parameter to the electronic device.

10. The virtual dressing method of claim 7, wherein when the data storage carrier is electrically connected to the electronic device, the data storage carrier transmits the three-dimensional user image and the body characteristic parameter to the electronic device.
